(19) United States
(12) Patent Application Publication
(10) Pub. No.: US 2008/0069679 A1
(43) Pub. Date: Mar. 20, 2008

(54) Industrial Robot

(76) Inventor: Toshiaki Shimada, Hiroshima (JP)

Correspondence Address: Nixon Peabody LLP, 401 9TH Street NW, Suite 900, Washington, DC, 20004-2128, US

(21) Appl. No.: 10/581,112

(22) PCT Filed: Sep. 26, 2005
(86) PCT No.: PCT/JP05/17610

§ 371 Date: May 31, 2006

(51) Int. Cl. B25J 9/06

(52) U.S. Cl. 414/744.5

(57) ABSTRACT

An industrial robot 1 is formed by connecting a base-side arm component 11 of a robot arm 3 to a base 2. A tip-side end of the base-side arm component 11 is connected to an intermediate arm component 12. Provided between the intermediate arm component 12 and a tip-side arm component 13 is an additional arm component 100. The additional arm component 100 is shorter than the tip-side arm component 13. A base-side end of the additional arm component 100 is detachably connected to the intermediate arm component 12. A tip-side end of the additional arm component 100 is detachably connected to the tip-side arm component 13.

### TECHNICAL FIELD

The present invention relates to an articulated industrial robot.

### BACKGROUND ART

Conventionally, for example, in various assemblage factories, cargo handling fields, etc., a workpiece which exists at a certain place is carried to a destination by an industrial robot. A well-known example of such an industrial robot used for carrying a workpiece is an articulated industrial robot having a robot arm which is formed by connecting a plurality of arm components as disclosed in Patent Document 1. Among the plurality of arm components of this industrial robot, a base-side arm component provided on the base side is swingably connected to a base by a connection shaft which extends generally horizontally. A tip-side arm component provided on the tip side is swingably connected to the tip-side end of the base-side arm component by a connection shaft which extends generally horizontally. The tip-side end of the tip-side arm component is provided with a wrist for grasping a workpiece. The tip-side arm component and the base-side arm component are swung around the connection shafts by actuators to move the wrist, whereby the workpiece is carried to a destination.

Generally, such an industrial robot as disclosed in Patent Document 1 have a variety of applications in accordance with the length and weight capacity of robot arms. When such an industrial robot is introduced to a work field, an optimum type of robot is selected in consideration of the route of carrying a workpiece, the distance of carriage, the size and weight of the workpiece, etc.

### [Patent Document 1] Japanese Patent Publication for Opposition No. 7-115312

### DISCLOSURE OF INVENTION

### Problems to be Solved by the Invention

However, the workpiece carried by the industrial robot as disclosed in Patent Document 1 and the route of carrying the workpiece vary among work fields, and therefore, various detailed requirements are imposed on the movement and shape of the robot arms. In some circumstances, these requirements cannot be met by existing types of robots that are prepared. In such cases, it is necessary to develop a robot customized to meet the requirements of a desired work field. In a work field to which such an industrial robot is introduced, a workpiece can be changed to a different type, or the route of carrying the workpiece can be changed, after the introduction of the robot. If the carriage of the workpiece by the already-introduced industrial robot becomes difficult because of such changes, a newly-selected robot has to be introduced. Development of the customized robot and introduction of the newly-selected robot incur a great equipment cost, and as a result, the production cost greatly increases.

The present invention was conceived in view of the above circumstances. An objective of the present invention is to provide an industrial robot wherein detailed demands on the movements and shape of robot arms are readily met such that the versatility in work fields is improved, and as a result, various types of workpieces can be carried without developing a special-purpose robot or introducing a newly-selected robot, so that the equipment cost and production cost are reduced.

### Means for Solving the Problems

To achieve the above objective, according to the first invention, a first arm component of a robot arm can be replaced by a second arm component.

Specifically, the first invention is directed to an industrial robot, comprising: a robot arm including a plurality of first arm components swingably connected to one another; and a base to which one of the first arm components at a base-side end of the robot arm is connected, wherein each of the first arm components has a connector which is detachably connected to a neighboring one of the first arm components, and the connector is connectable to a replacement second arm component in place of the neighboring first arm component.

With the above structure, the first arm component can be replaced by the second arm component which moves differently from the first arm component. Therefore, the movement of the robot arm can be changed. Further, the first arm component can be replaced by the second arm component which has a different shape from the first arm component. Therefore, the shape of the robot arm can be changed.

To achieve the above objective, according to the second invention, a second arm component can be added to a robot arm formed by first arm components.

Specifically, the second invention is directed to an industrial robot, comprising: a robot arm including a plurality of first arm components swingably connected to one another; and a base to which one of the first arm components at the base-side end of the robot arm is connected, wherein each of the first arm components has a connector which is detachably connected to a neighboring one of the first arm components, and the connector is connectable to an additional second arm component added to the robot arm and included in the robot arm together with the first arm components.

With the above structure, the shape of the robot arm can be changed by adding the second arm component, and the number of articulations can be increased to change the movement of the robot arm. Further, the second arm component which moves differently from the first arm component can be added to the robot arm, and this also changes the movement of the robot arm.

According to the third invention, in the first or second invention, the length of the second arm component in its arm axis direction is different from the length of the first arm component in its arm axis direction.

With the above structure, the length of the robot arm can be changed.

According to the fourth invention, in the first or second invention, the second arm component is divided into a base-side part and a tip-side part at an axially intermediate position; and the second arm component has rotation means for rotating the tip-side part around its arm axis relative to the base-side part.

With the above structure, the robot arm can be rotated around the arm axis at an axially intermediate position.

According to the fifth invention, in the first or second invention, the second arm component includes a movable member and a moving device for moving the movable member in the arm axis direction of the second arm component.

With the above structure, the movable member is moved by the moving device, so that the flexibility in movement of the robot arm is improved.

### Effects of the Invention

According to the first invention, a first arm component of the robot arm can be replaced by a second arm component which has different movement and shape from those of the first arm component. Thus, the movement and shape of the robot arm can be readily modified according to detailed requirements in a work field, and therefore, the versatility of the industrial robot can be improved. Therefore, it is not necessary to develop a robot customized to a certain work field, and various workpieces can be carried without introducing a new-type robot into the work field. As a result, the equipment cost can be reduced, and accordingly, the production cost can be reduced.

According to the second invention, a second arm component which has different movement and shape from those of the first arm component of the robot arm can be added to the robot arm. Therefore, the versatility of the industrial robot is improved as in the first invention, so that the equipment cost can be reduced, and accordingly, the production cost can be reduced.

According to the third invention, the length of the second arm component in its arm axis direction is different from the length of the first arm component in its arm axis direction. Therefore, the length of the robot arm can be changed.

According to the fourth invention, the second arm component is divided into a base-side part and a tip-side part. The tip-side part is rotatable around the arm axis relative to the base-side part. Therefore, the flexibility in movement of the robot arm can be improved.

According to the fifth invention, the movable part of the second arm component is moved in the arm axis direction of the second arm component. Therefore, the flexibility in movement of the robot arm can be improved.

### BRIEF DESCRIPTION OF DRAWINGS

FIG. 1 is a side view of an industrial robot according to an embodiment of the present invention.

FIG. 2 is a back view of the industrial robot.

FIG. 3 is an enlarged back view of the industrial robot which shows the base side of a base-side arm component and elements therearound.

FIG. 4 is an enlarged back view of the industrial robot which shows the tip side of the base-side arm component and elements therearound.

FIG. 5 is a block diagram of the industrial robot.

FIG. 6 illustrates the internal structure of the base-side arm actuator.

FIG. 7 is an end view of the base-side arm actuator seen from the closing member side.

FIG. 8 is a schematic illustration of the industrial robot.

FIG. 9 is an illustration corresponding to FIG. 1 in which an additional arm component is connected.

FIG. 10 is an illustration corresponding to FIG. 8 in which an additional arm component is connected.

FIG. 11 is a side view of the additional arm component and an additional arm actuator.

FIG. 12 is an illustration corresponding to FIG. 1 in which a replacement arm component is connected.

FIG. 13 is a cross-sectional view taken along line A-A of FIG. 12.

FIG. 14 is a side view of the replacement arm component and a tip-side arm actuator.

FIG. 15 is an illustration corresponding to FIG. 8 in which a replacement arm component is connected.

FIG. 16 is an illustration corresponding to FIG. 12 in which the tip-side part of the replacement arm component is rotated around the arm axis.

FIG. 17 is an illustration corresponding to FIG. 13 in which a connector is provided between the base-side part and tip-side part of the replacement arm component.

FIG. 18 is an end view of the connector of FIG. 17 seen from the base side.

FIG. 19 is a side view of the replacement arm component provided with a wrist actuator.

FIG. 20 is a side view of the replacement arm component provided with a wrist actuator and an arm rotator.

FIG. 21 is a side view of a replacement arm component formed by three divisional parts connected in the arm axis direction.

FIG. 22 is a side view of a replacement arm component configured to bend at an axially intermediate position.

### DESCRIPTION OF REFERENCE NUMERALS

1 Industrial robot

2 Base

3 Robot arm

11 Base-side arm component (First arm component)

12 Intermediate arm component (Second arm component)

13 Tip-side arm component (Third arm component)

11a, 12a, 13a Base-side connector

11b, 12b, 13b Tip-side connector

100 Additional arm component (Additional second arm component)

120 Replacement arm component (Replacement second arm component)

121 Base side part

122 Tip side part

140a Rod (Movable member)

140b Principal part (Moving device)

### BEST MODE FOR CARRYING OUT THE INVENTION

Hereinafter, an embodiment of the present invention is described with reference to the drawings. It should be noted that the following descriptions of the preferred embodiment are merely exemplary in essential and do not intend to limit the present invention, applications thereof, or uses thereof.

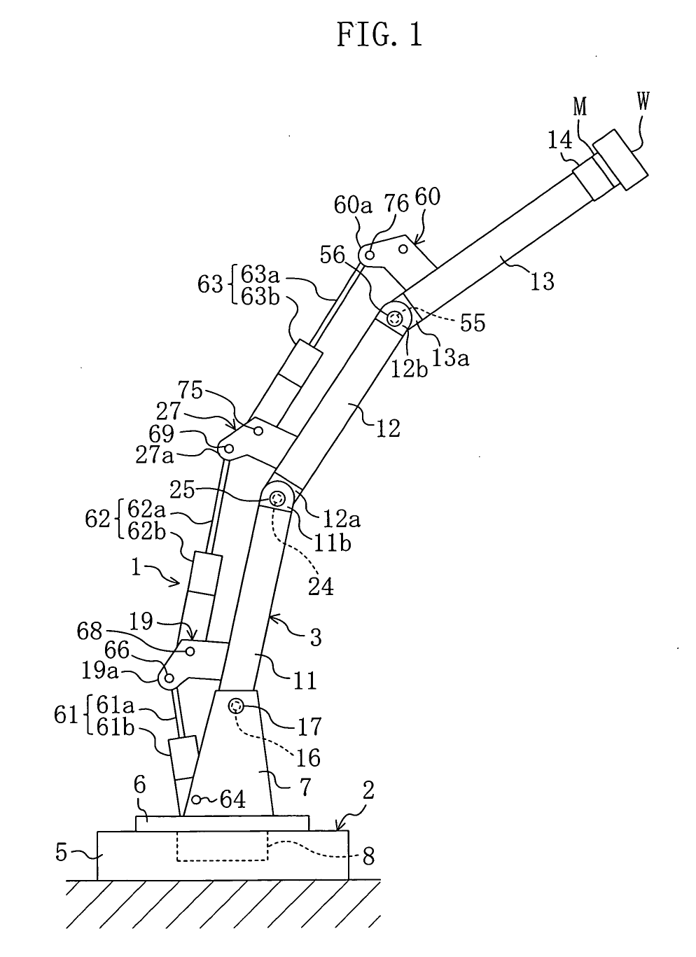

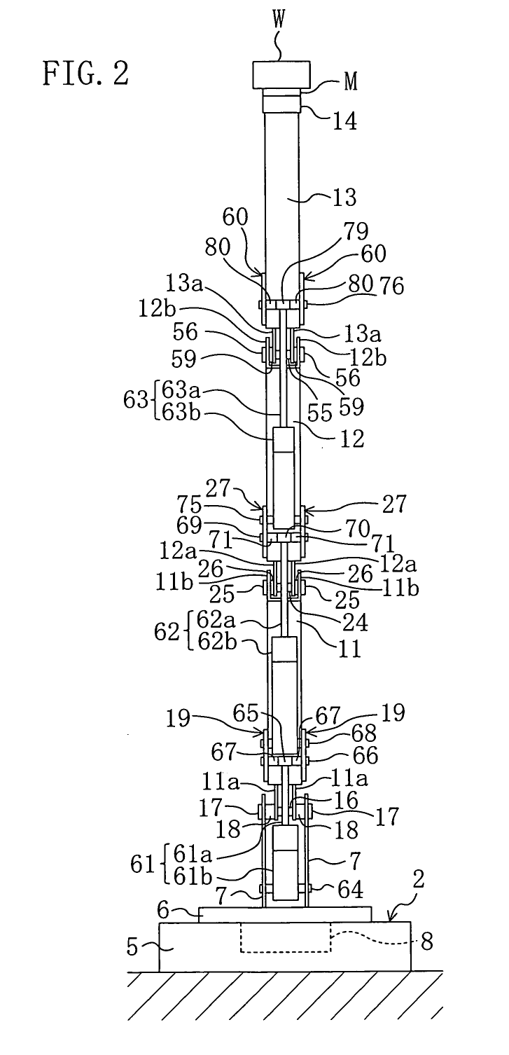

FIG. 1 and FIG. 2 show an articulated industrial robot 1 according to an embodiment of the present invention. For example, the robot 1 is used for carrying a workpiece W in a vehicle assembly factory, a load handling field, etc.

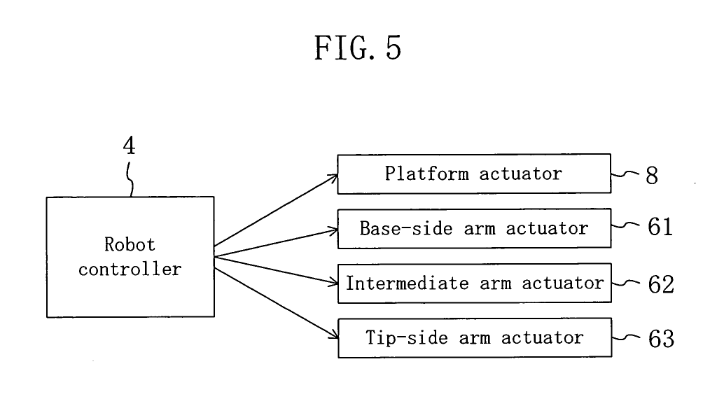

The robot 1 is formed by a base 2 fixed to the ground, a robot arm 3 attached to the base 2, and a robot controller 4 (shown in FIG. 5). The base 2 is formed by a principal part 5 which constitutes the lower part of the base 2, a rotating platform 6 provided on the upper surface of the principal part 5, and a pair of robot arm supporting elements 7 provided on the upper surface of the rotating platform 6. The rotating platform 6 supported on the principal part 5 by a pivotal shaft (not shown) which extends generally vertically. The rotating platform 6 is actuated by a platform actuator 8 to rotate around the pivotal shaft. The platform actuator 8 is formed by, for example, a motor, a speed reducer, etc. The robot arm supporting elements 7 each has a plate-like shape which extends upwardly from the upper surface of the rotating platform 6 as also shown in FIG. 2. The robot arm supporting elements 7 face each other and are fixed to the rotating platform 6 at the lower ends.

The robot arm 3 includes a base-side arm component 11, an intermediate arm component 12 and a tip-side arm component 13, which are sequentially provided from the base 2 to the tip side. The tip-side end of the tip-side arm component 13 is provided with a wrist 14 to which a material hand M is attached. The arm components 11 to 13 are each formed by a hollow rod which extends generally vertically and correspond to the first arm components in the claimed inventions.

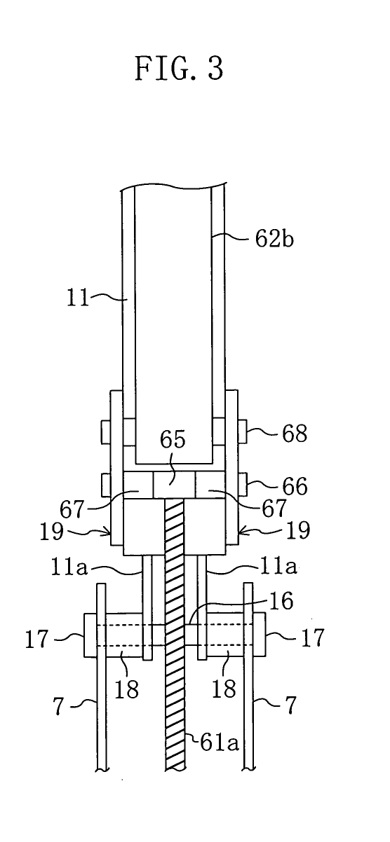

As shown in FIG. 2 and FIG. 3, an end of the base-side arm component 11 which is closer to the base 2 is provided with a pair of base-side connectors 11a protruding in the arm axis direction which is equal to the longitudinal direction of the arm. The base-side connectors 11a face each other with a certain interval therebetween. The base-side arm component 11 is located such that the base-side connectors 11a are between the robot arm supporting elements 7 and extends generally in parallel to the supporting elements 7. With this arrangement, the base-side connectors 11a are swingably connected to the robot arm supporting elements 7 at a position in the vicinity of the upper end of the supporting elements 7 by a base-side connection shaft 16 which extends generally horizontally. The base-side connection shaft 16 penetrates through the robot arm supporting elements 7 and the base-side connectors 11a. The both ends of the base-side connection shaft 16 are provided with stoppers 17 for preventing the connection shaft 16 from dropping out. The stoppers 17 are detachably attached using a fastening member, or the like. Also provided between the robot arm supporting elements 7 and the base-side connectors 11a are cylindrical spacers 18 through which the base-side connection shaft 16 is inserted.

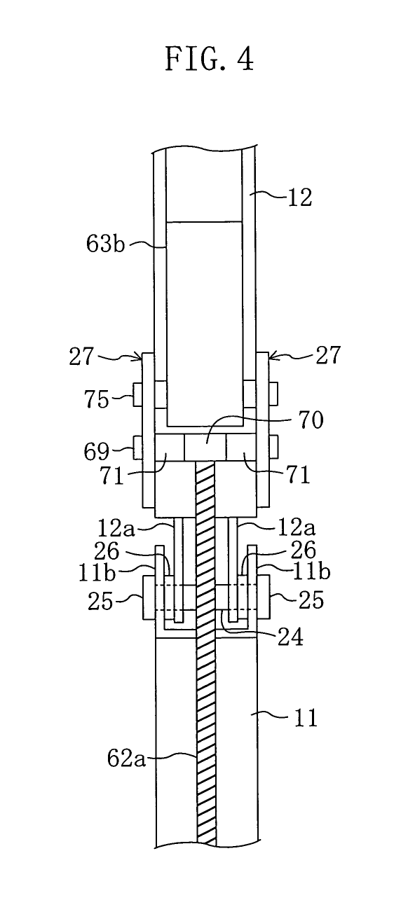

The outer surface of an end of the base-side arm component 11 which is closer to the base 2 is provided with a pair of first plate members 19 protruding in a radial direction of the arm component 11 as also shown in FIG. 1. The first plate members 19 have the same shape and extend generally in parallel to each other with a certain interval therebetween as shown in FIG. 2. Referring to FIG. 1, the protrusion tip of each first plate member 19 has a bent nose 19a which is bent toward the base-side end of the base-side arm component 11. Referring to FIG. 4, the tip-side end of the base-side arm component 11 is provided with a pair of tip-side connectors 11b protruding in the arm axis direction. The tip-side connectors 11b face each other with a certain interval therebetween. The tip-side connectors 11b have generally the same shape as that of the base-side connectors 11a.

An end of the intermediate arm component 12 which is closer to the base 2 is provided with base-side connectors 12a which have generally the same shape as that of the base-side connectors 11a of the base-side arm component 11. The intermediate arm component 12 is located such that the base-side connectors 12a are between the tip-side connectors 11b of the base-side arm component 11 and extends generally in parallel to the tip-side connectors 11b. With this arrangement, the base-side connectors 12a are swingably connected to the base-side arm component 11 by an intermediate connection shaft 24 which extends generally horizontally. The intermediate connection shaft 24 has the same structure as that of the base-side connection shaft 16. The both ends of the intermediate connection shaft 24 are provided with stoppers 25 as is the base-side connection shaft 16. Also provided between the tip-side connectors 11b of the base-side arm component 11 and the base-side connectors 12a of the intermediate arm component 12 are cylindrical spacers 26.

The tip-side end of the intermediate arm component 12 is provided with a pair of tip-side connectors 12b protruding in the arm axis direction as shown in FIG. 2. The tip-side connectors 12b face each other with a certain interval therebetween. The tip-side connectors 12b have generally the same shape as that of the base-side connectors 12a. The outer surface of the intermediate arm component 12 is provided with second plate members 27 as also shown in FIG. 1. Each of the second plate members 27 has a bent nose 27a as does the first plate member 19.

An end of the tip-side arm component 13 which is closer to the base 2 is provided with base-side connectors 13a as does the base-side arm component 11. The tip-side arm component 13 is located such that the base-side connectors 13a are generally in parallel to the tip-side connectors 12b of the intermediate arm component 12. With this arrangement, the base-side connectors 13a are swingably connected to the intermediate arm component 12 by a tip-side connection shaft 55 which extends generally horizontally. The tip-side connection shaft 55 has the same structure as that of the base-side connection shaft 16. The both ends of the tip-side connection shaft 55 are provided with stoppers 56 as is the base-side connection shaft 16. Also provided between the tip-side connectors 12b of the intermediate arm component 12 and the base-side connectors 13a of the tip-side arm component 13 are cylindrical spacers 59. That is, the connection structure of the base-side arm component 11 and the intermediate arm component 12 and the connection structure of the intermediate arm component 12 and the tip-side arm component 13 have the same structure. Therefore, for example, the base-side arm component 11 and the intermediate arm component 12 can be replaced by each other.

As also shown in FIG. 1, the outer surface of an end of the tip-side arm component 13 which is closer to the base 2 is provided with third plate members 60. Each of the third plate members 60 has a bent nose 60a as does the first plate member 19.

The base-side arm component 11 is actuated by a base-side arm actuator 61. The base-side arm actuator 61 includes a rod 61a and a principal part 61b for axially moving the rod 61a.

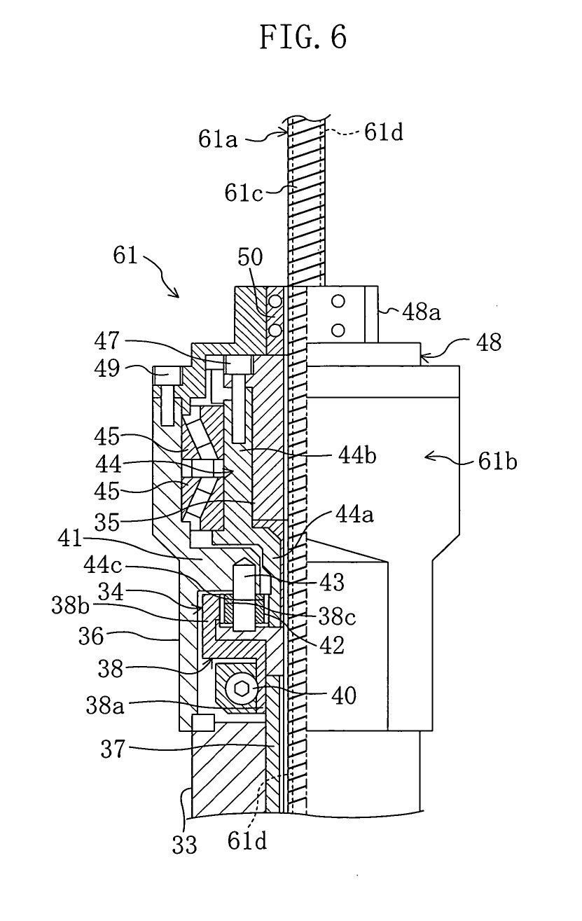

The base-side arm actuator 61 may be, for example, an arm actuator disclosed in Japanese Laid-Open Patent Publication No. 2003-343679. Specifically, referring to FIG. 6, the rod 61a is formed by a trapezoidal screw shaft which has a trapezoidal thread groove 61c in the outer surface between the axial ends. The outer surface of the rod 61a has two guide grooves 61d extending between the axial ends. The guide grooves 61d are circumferentially separated by about 180° from each other. The principal part 61b includes a motor 33, a speed reduction mechanism 34 and a nut 35, which are aligned in the axial direction of the rod 61a. The speed reduction mechanism 34 and the nut 35 are contained in a cylindrical casing 36 extending in the axial direction of the rod 61a. An output shaft 37 of the motor 33 has a cylindrical shape through which the rod 61a is inserted and extends into the casing 36.

The speed reduction mechanism 34 is formed by a planetary gear train. An internal gear 38 of the speed reduction mechanism 34 has a smaller diameter part 38a on the motor 33 side and a larger diameter part 38b on the nut 35 side. The smaller diameter part 38a and the larger diameter part 38b are an integral structure. The smaller diameter part 38a is fixed to the output shaft 37 by a bolt 40 so as to rotate integrally with the output shaft 37. The inner surface of the larger diameter part 38b has internal teeth 38c. The number of the internal teeth 38c is, for example, 61.

The inner surface of an axially intermediate part of the casing 36 has an annular attachment portion 41 protruding from the inner surface. A supporting shaft 43 is fixed to the attachment portion 41. The supporting shaft 43 rotatably supports a planet pinion 42 meshed with the internal teeth 38c of the internal gear 38. This structure has a plurality of planet pinions 42 and supporting shafts 43 along the periphery of the internal gear 38. The number of teeth of each planet pinion 42 is, for example, 16.

On the inner surface of the casing 36, a cylindrical output rotator 44 which functions as a sun gear is rotatably supported through two bearings 45. The output rotator 44 has a smaller diameter part 44a on the motor 33 side and a larger diameter part 44b on the other side. The smaller diameter part 44a and the larger diameter part 44b are an integral structure. The outer surface of the smaller diameter part 44a has teeth 44c meshed with the planet pinions 42. The number of teeth 44c of the output rotator 44 is, for example, 29.

The bearings 45 are fixed onto the outer surface of the larger diameter part 44b of the output rotator 44. The nut 35 is fit in the inner surface of the larger diameter part 44b. The nut 35 is fixed to the output rotator 44 by a bolt 47. The inner surface of the nut 35 has a ridge (not shown) meshed with the thread groove 61c of the rod 61a.

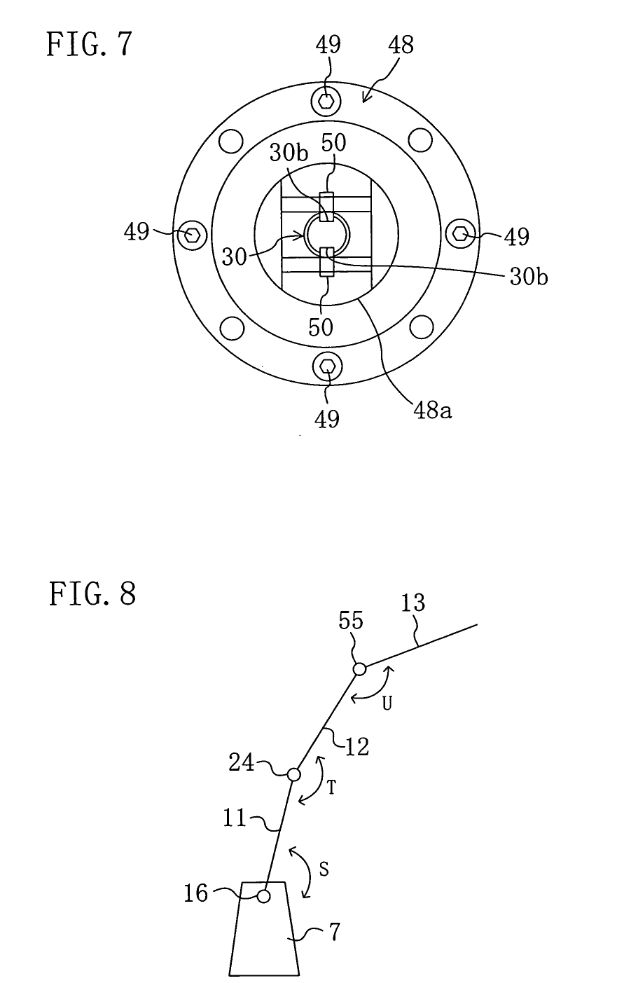

The casing 36 is provided with fixing means for restricting the rotation of the rod 61a. Specifically, a closing member 48 is fixed to the casing 36 by a bolt 49 to close an opening at the end surface of the casing 36. The closing member 48 is provided with an attachment portion 48a protruding outwardly of the casing 36. As also shown in FIG. 7, the attachment portion 48a is provided with two plate-like guiding members 50 as the fixing means. The guiding members 50 fit in the guide grooves 61d of the rod 61a.

The speed reduction mechanism 34 may be a gear mechanism different from the planetary gear train. The rod 61a and the nut 35 may be a ball screw shaft and a ball screw nut, respectively.

The principal part 61b having the above-described structure is located between the robot arm supporting elements 7 as shown in FIG. 2 and is rotatably attached to the robot arm supporting elements 7 by a shaft 64 which extends generally in parallel to the base-side connection shaft 16. Referring to FIG. 3, an attachment portion 65 extending in a direction perpendicular to the rod 61a is fixed to an end of the rod 61a. The attachment portion 65 is located between the bent noses 19a of the first plate members 19 and rotatably and detachably attached to the bent noses 19a by a shaft 66. Provided between the attachment portion 65 and the bent noses 19a are spacers 67.

Referring to FIG. 1, the intermediate arm component 12 is actuated by an intermediate arm actuator 62. The intermediate arm actuator 62 has a rod 62a and a principal part 62b as does the base-side arm actuator 61. Referring to FIG. 2, the principal part 62b is rotatably attached to the first plate members 19 by a shaft 68 as in the base-side arm actuator 61. An attachment portion 70 provided at an end of the rod 62a is attached to the bent noses 27a of the second plate members 27 by a shaft 69. It should be noted that reference numeral 71 denotes spacers.

The tip-side arm component 13 is actuated by a tip-side arm actuator 63. The tip-side arm actuator 63 has a rod 63a and a principal part 63b as does the base-side arm actuator 61. As in the base-side arm actuator 61, the principal part 63b is rotatably attached to the second plate members 27 by a shaft 75. An attachment portion 79 provided at an end of the rod 63a is attached to the bent noses 60a of the third plate members 60 by a shaft 76. It should be noted that reference numeral 80 denotes spacers.

Referring to FIG. 5, the platform actuator 8, the base-side arm actuator 61, the intermediate arm actuator 62 and the tip-side arm actuator 63 are connected to the robot controller 4 and work independently of one another according to instructions from the robot controller 4. Although not shown, the wrist 14 is rotatable around the arm axis and controlled by the robot controller 4.

For example, when the robot controller 4 starts the motor 33 of the base-side arm actuator 61 shown in FIG. 6, the output shaft 37 rotates the internal gear 38. The rotation of the internal gear 38 rotates the planet pinions 42 so that the output rotator 44 and the nut 35 rotate in a direction opposite to the rotation direction of the internal gear 38. The rotation speed of the nut 35 is reduced by the speed reduction mechanism 34 to a predetermined speed, so that the torque of the nut 35 is increased. Meanwhile, the rod 61a is prevented by the guiding members 50 from rotating and therefore axially travels along the guiding members 50. As the rod 61a axially travels, the base-side arm component 11 swings around the base-side connection shaft 16 as schematically illustrated in FIG. 8 (in the direction shown by arrow S).

The force for swinging the base-side arm component 11 is obtained by the thrust of the rod 61a which is produced by the principal part 61b. The thrust of the rod 61a is secured high because the speed reduction mechanism 34 provided between the motor 33 and the nut 35 increases the torque of the nut 35. Therefore, the force for swinging the base-side arm component 11 is sufficiently obtained. The swing direction of the base-side arm component 11 can be changed by changing the rotation direction (forward or reverse) of the motor 33. The swing angle of the base-side arm component 11 can be set by changing the operating period of the motor 33. The swing speed of the base-side arm component 11 can be changed by changing the rotation speed of the rod 61a. The intermediate arm component 12 is actuated by the intermediate arm actuator 62 to swing in a direction indicated by arrow T in FIG. 8. The tip-side arm component 13 is actuated by the tip-side arm actuator 63 to swing in a direction indicated by arrow U in FIG. 8.

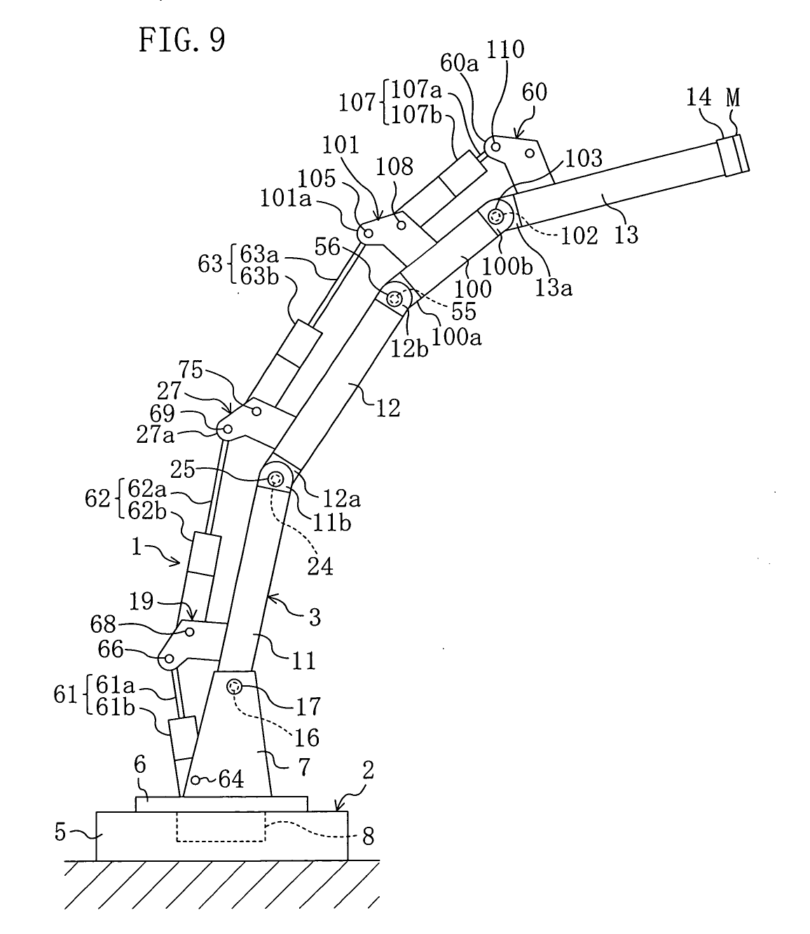

In the robot arm 3 of the industrial robot 1, the tip-side connectors 12b of the intermediate arm component 12 and the base-side connectors 13a of the tip-side arm component 13 are detachably connected. Therefore, an additional arm component 100 can be added to the robot arm 3 as shown in FIG. 9 by detaching the connectors 12b and 13a. The additional arm component 100 is formed by a hollow rod as is the base-side arm component 11 and corresponds to the additional second arm component of the claimed inventions. The length of the additional arm component 100 in its arm axis direction is smaller than the length of the intermediate arm component 12 in its arm axis direction. As also shown in FIG. 11, an end of the additional arm component 100 which is closer to the base 2 is provided with base-side connectors 100a as is the intermediate arm component 12. The additional arm component 100 is located such that the base-side connectors 100a are between the tip-side connectors 12b of the intermediate arm component 12 and generally in parallel to the intermediate arm component 12. With this arrangement, the base-side connectors 100a are swingably connected to the intermediate arm component 12 by the tip-side connection shaft 55. The outer surface of the end of the additional arm component 100 which is closer to the base 2 is provided with fourth plate members 101 each of which has a bent nose 101a as does the first plate member 19.

The tip-side end of the additional arm component 100 is provided with a pair of tip-side connectors 100b protruding in its arm axis direction as are the tip-side connectors 12b of the intermediate arm component 12. Provided between the tip-side connectors 100b are the base-side connectors 13a of the tip-side arm component 13. With this arrangement, the tip-side connectors 100b are swingably connected to the tip-side arm component 13 by an additional connection shaft 102 which extends generally horizontally. The additional connection shaft 102 has the same structure as that of the base-side connection shaft 16. The both ends of the additional connection shaft 102 are provided with stoppers 103 as is the base-side connection shaft 16. Also provided between the tip-side connectors 100b of the additional arm component 100 and the base-side connectors 13a of the tip-side arm component 13 are cylindrical spacers (not shown).

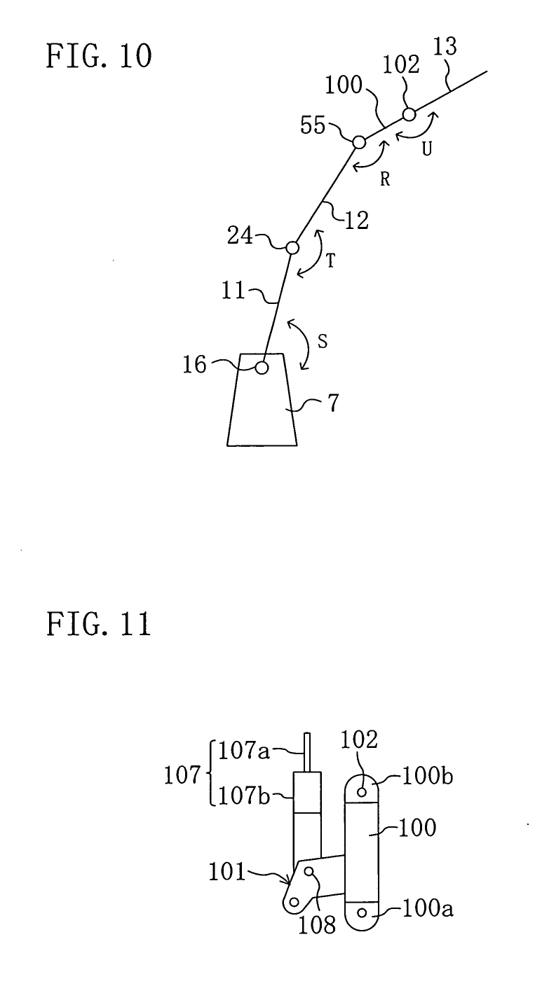

The tip-side end of the rod 63a of the tip-side arm actuator 63 is attached to the bent noses 101a of the fourth plate members 101 of the additional arm component 100 by a shaft. Thus, as schematically illustrated in FIG. 10, the tip-side arm actuator 63 actuates the additional arm component 100 to swing around the tip-side connection shaft 55 (in the direction shown by arrow R).

The tip-side arm component 13 is actuated by an additional arm actuator 107. The additional arm actuator 107 has a rod 107a and a principal part 107b as does the base-side arm actuator 61. The principal part 107b is rotatably attached to the fourth plate members 101 by a shaft 108. An attachment portion (not shown) provided at an end of the rod 107a is attached to the bent noses 60a of the third plate members 60 by a shaft 110. Although not shown, the additional arm actuator 107 is connected to the robot controller 4 and is controlled by the robot controller 4. The attachment structure of the additional arm actuator 107 is the same as that of the intermediate arm actuator 62.

By adding the additional arm component 100, the robot arm 3 has one additional articulation. As a result, the robot arm 3 has a different shape and gains improved flexibility in movement.

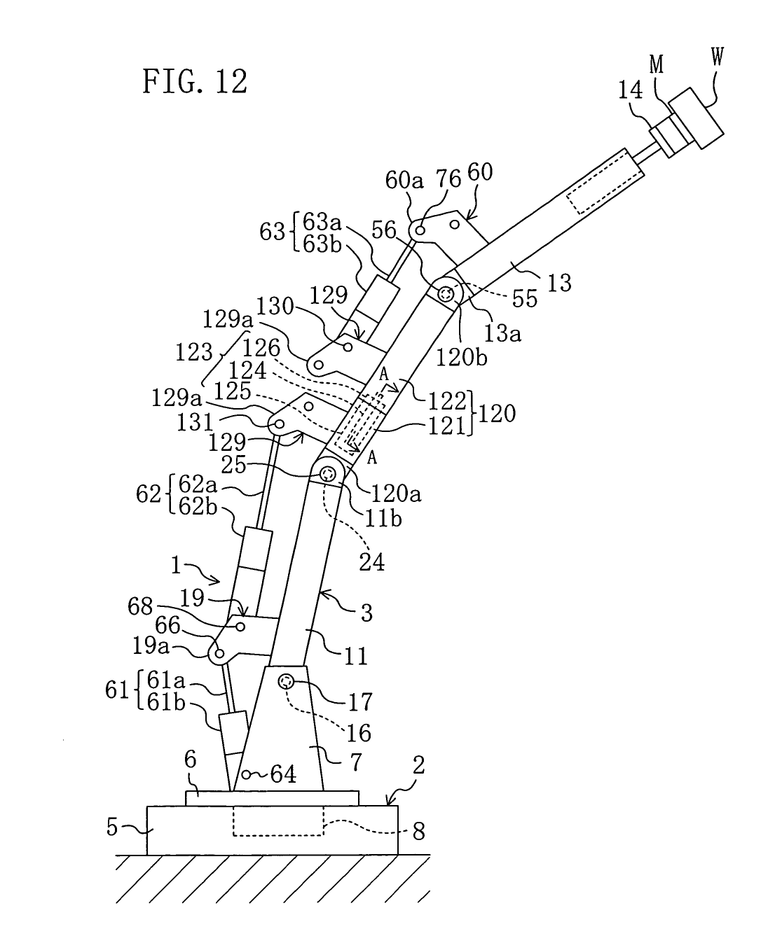

In the robot arm 3 of FIG. 1, the intermediate arm component 12 can be replaced by a replacement arm component 120 as shown in FIG. 12 by separating the tip-side connectors 12b of the intermediate arm component 12 and the base-side connectors 13a of the tip-side arm component 13 and separating the base-side connectors 12a of the intermediate arm component 12 and the tip-side connectors 11b of the base-side arm component 11. The replacement arm component 120 is formed by a hollow rod as is the base-side arm component 11 and corresponds to the replacement second arm component of the claimed inventions.

An end of the replacement arm component 120 which is closer to the base 2 is provided with base-side connectors 120a as does the intermediate arm component 12. The replacement arm component 120 is located such that the base-side connectors 120a are between the tip-side connectors 11b of the base-side arm component 11 and generally in parallel to the tip-side connectors 11b. With this arrangement, the base-side connectors 120a are swingably connected to the base-side arm component 11 by the intermediate connection shaft 24.

The tip-side end of the replacement arm component 120 is provided with a pair of tip-side connectors 120b protruding in the arm axis direction as is the base-side arm component 11. Provided between the tip-side connectors 120b are the base-side connectors 13a of the tip-side arm component 13. With this arrangement, the tip-side connectors 120b are swingably connected to the tip-side arm component 13 by a tip-side connection shaft 55 which extends generally horizontally. The connection structure of the replacement arm component 120 is the same as that of the intermediate arm component 12.

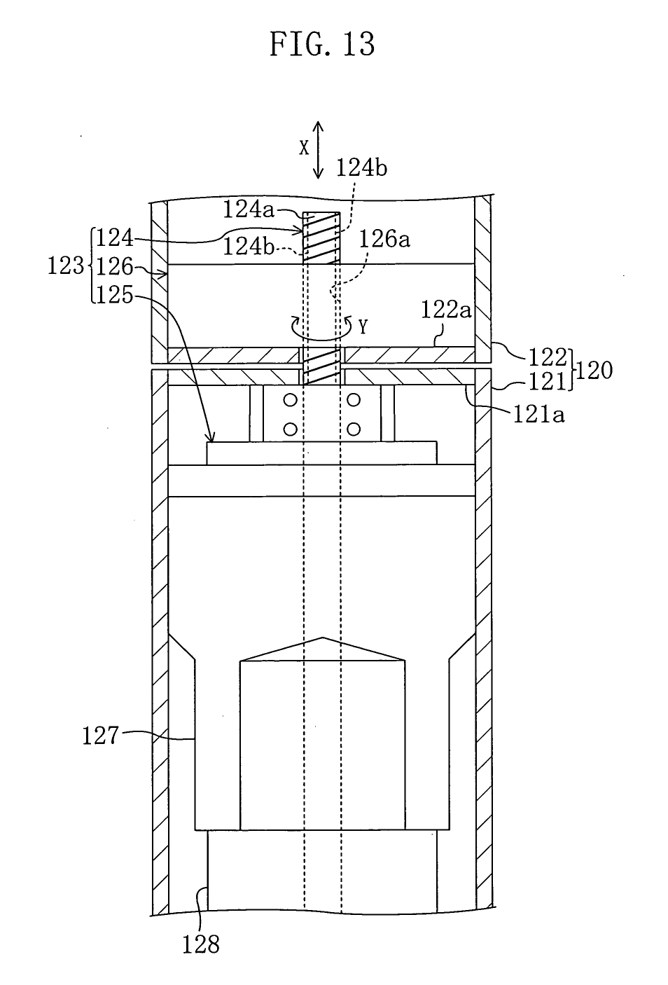

The replacement arm component 120 is divided at an axially intermediate position into a base-side part 121 and a tip-side part 122 and has an arm rotator 123 (rotation means) for rotating the tip-side part 122 around the arm axis relative to the base-side part 121. As shown in FIG. 13, the base-side part 121 has a wall 121a at an end closer to the tip-side part 122, and the tip-side part 122 has a wall 122a at an end closer to the base-side part 121. The walls 121a and 122a are connected by connecting means (not shown) so as not to be separated from each other in the arm axis direction but rotatable around the arm axis.

The arm rotator 123 includes a drive shaft 124 and a moving device 125 for axially moving the drive shaft 124, which have the same structures as the rod 61a and the principal part 61b of the base-side arm actuator 61, respectively. The drive shaft 124 has a thread groove 124a and two axially-extending guide grooves 124b. A casing 127 and motor 128 of the moving device 125 are contained in the hollow region of the base-side part 121. The casing 127 contained in the hollow region is fixed to the base-side part 121. The drive shaft 124 protrudes out at the center of the wall 121a. This protruding portion penetrates through the center of the wall 122a of the tip-side part 122 and then extends into the tip-side part 122. The hollow region of the tip-side part 122 contains a threaded member 126 which meshes with the drive shaft 124. The threaded member 126 is fixed to the tip-side part 122. The threaded member 126 constitutes a part of the arm rotator 123. The threaded member 126 has a hole 126a which has a shape to mesh with the thread groove 124a of the drive shaft 124.

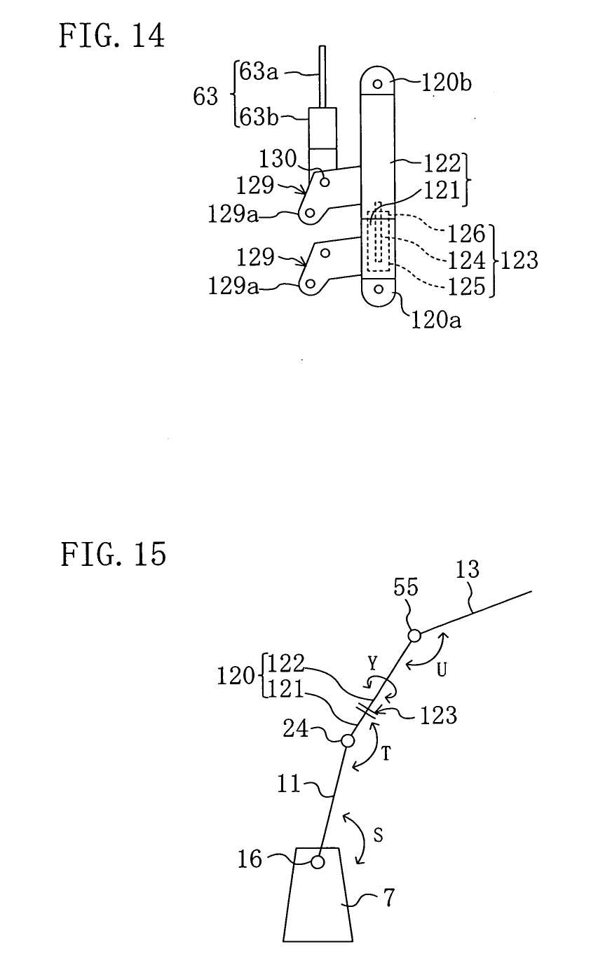

As also shown in FIG. 14, the outer surface of the base-side part 121 and the outer surface of the tip-side part 122 are provided with fifth plate members 129 each of which has a bent nose 129a as does the first plate member 19. As shown in FIG. 12, the principal part 63b of the tip-side arm actuator 63 is attached to the fifth plate members 129 of the tip-side part 122 by a shaft 130. An end of the rod 62a of the intermediate arm actuator 62 is attached to the fifth plate members 129 of the base-side part 121 by a shaft 131. Thus, the replacement arm component 120 is actuated by the intermediate arm actuator 62 to swing around the intermediate connection shaft 24.

By starting the motor 128 of the arm rotator 123, the drive shaft 124 axially travels. As the drive shaft 124 axially travels, the threaded member 126 meshed with the drive shaft 124 rotates around the drive shaft 124. As a result, as schematically illustrated in FIG. 15, the tip-side part 122 of the replacement arm component 120 rotates around the arm axis relative to the base-side part 121. The torque of the tip-side part 122 is obtained by the thrust of the drive shaft 124 which is produced by the moving device 125. The thrust of the drive shaft 124 is secured high by a speed reduction mechanism which reduces the rotation speed of the motor 128. Therefore, the torque of the tip-side part 122 is sufficiently obtained. The rotation direction of the tip-side part 122 can be changed by changing the rotation direction (forward or reverse) of the motor 128. The rotation angle of the tip-side part 122 can be set by changing the operating period of the motor 128. The rotation speed of the tip-side part 122 can be changed by changing the rotation speed of the motor 128.

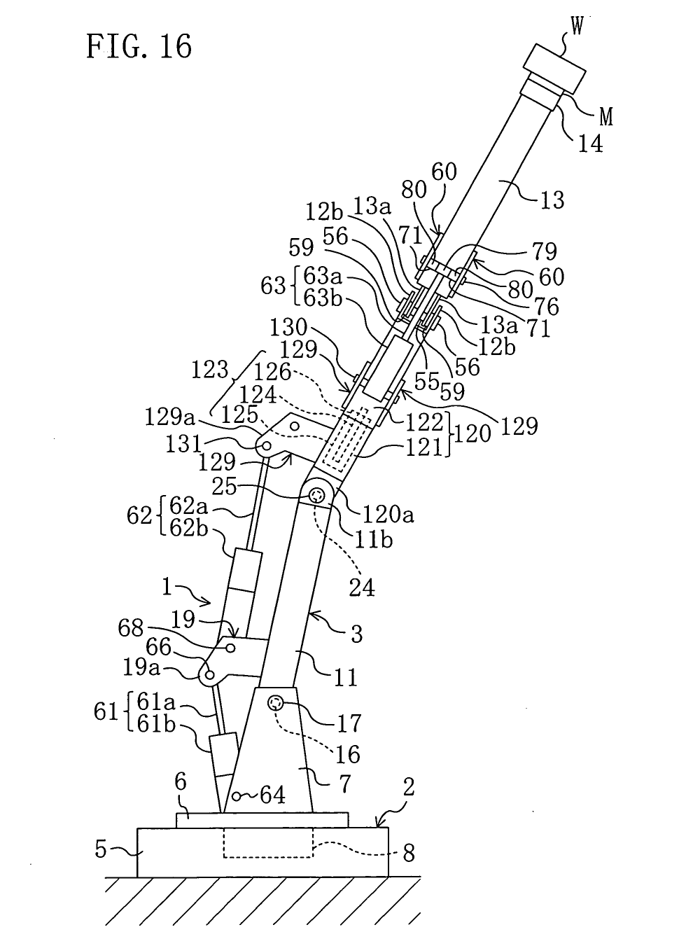

When the tip-side part 122 in the state shown in FIG. 12 is rotated by the arm rotator 123 by about 90° to be in the state shown in FIG. 16, the tip-side arm component 13, the tip-side connection shaft 55 and the tip-side arm actuator 63 rotate in the same direction by the same rotation angle. By rotating the tip-side arm component 13 together with the tip-side connection shaft 55 and the tip-side arm actuator 63, the swing direction of the tip-side arm component 13 can be changed. As a result, the robot arm 3 gains improved flexibility in movement.

Now consider a case where the industrial robot 1 is installed in a vehicle assembly factory. In this case, although not shown, a steering wheel (workpiece W) on a pallet, or the like, is grasped by the wrist 14 and transferred to a driver's seat of a vehicle through a door opening in a body of the vehicle. Thereafter, a steering shaft of the vehicle body is inserted through an attachment hole of the steering wheel. For example, also in the process of installing a seat in the vehicle body, the seat (workpiece W) is grasped outside the vehicle compartment and then transferred into the vehicle compartment. Thereafter, attachment holes of the seat are aligned with attachment positions in the vehicle. Thus, in the process of transferring workpiece W grasped outside the vehicle compartment into the vehicle compartment, the transfer route is complicated because of pallets and vehicle parts distributed around the vehicle body. In this case, the arm rotator 123 is activated to change the swing direction of the tip-side arm component 13 as described above such that the arm components 11 to 13 and workpiece W do not interfere with the pallets or vehicle parts. The industrial robot 1 can also be used for purposes other than attaching vehicle interior parts, for example, for attaching tires to the vehicle body.

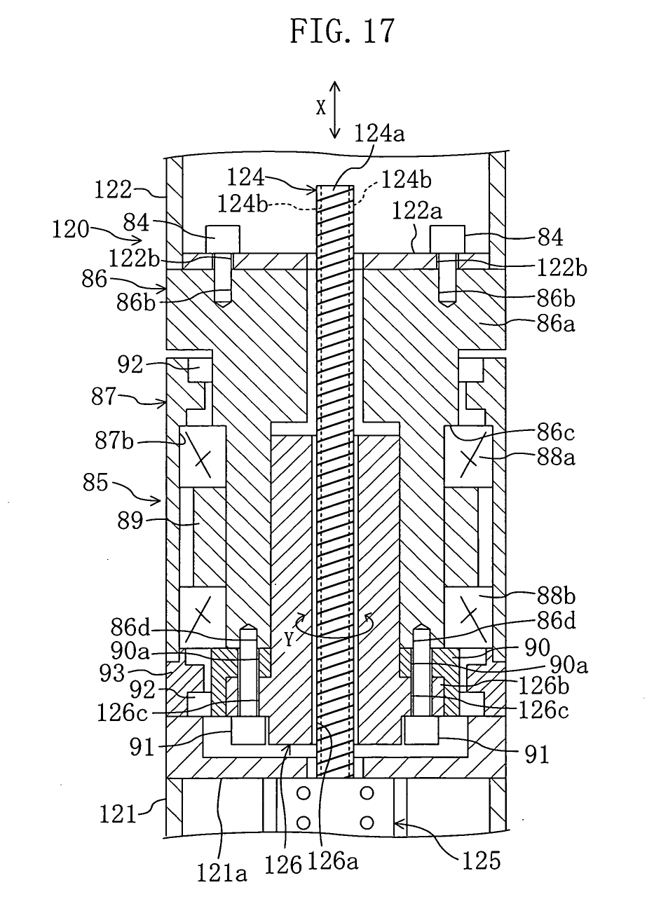

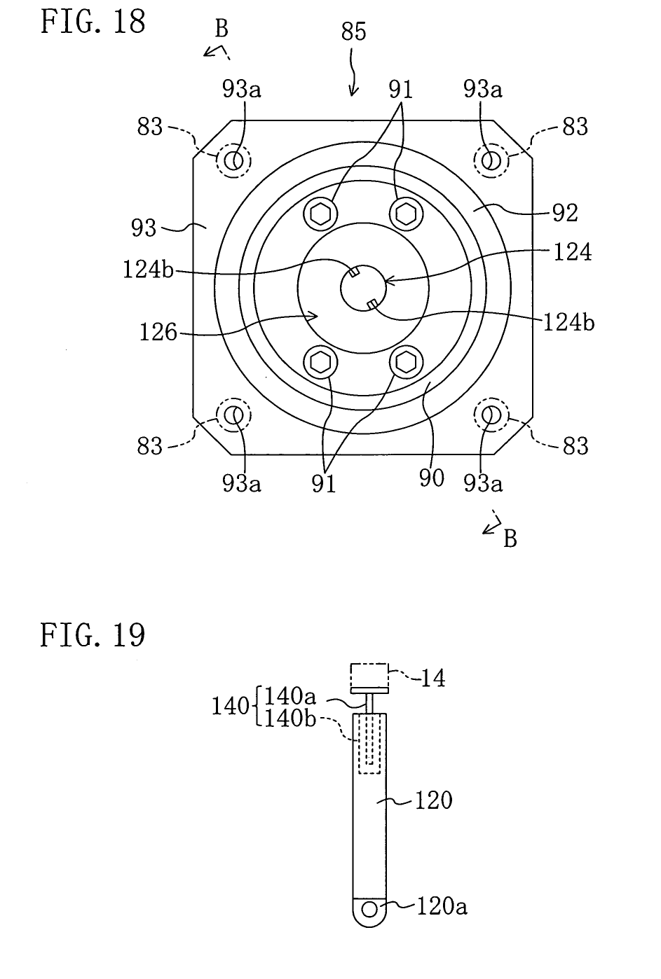

The base-side part 121 and the tip-side part 122 of the replacement arm component 120 may be connected by a connecting element 85 as shown in FIG. 17 and FIG. 18 so as not to be separated from each other in the arm axis direction but rotatable around the arm axis. It should be noted that FIG. 17 shows a cross section taken along line B-B of FIG. 18.

The connecting element 85 is located between the base-side part 121 and the tip-side part 122 as shown in FIG. 17. The base-side part 121 has a first cylindrical member 86 surrounding the drive shaft 124, a second cylindrical member 87 surrounding the outer surface of the first cylindrical member 86, and two bearings 88a and 88b provided between the outer surface of the first cylindrical member 86 and the inner surface of the second cylindrical member 87.

At an end of the first cylindrical member 86 which is adjacent to the tip-side part 122 is a flange 86a integrally formed by molding. The flange 86a has a plurality of axially-extending screw holes 86b opened in the surface closer to the tip-side part 122. The screw holes 86b are aligned along the circumference of the first cylindrical member 86 with certain intervals. The wall 122a of the tip-side part 122 has through holes 122b at positions corresponding to the screw holes 86b. Bolts 84 are inserted through the through holes 122b and meshingly inserted into the screw holes 86b, whereby the first cylindrical member 86 is fixedly fastened to the tip-side part 122.

An end surface of the first cylindrical member 86 which is closer to the base-side part 121 has a plurality of axially-extending screw holes 86d. The screw holes 86d are aligned along the circumference of the first cylindrical member 86 with certain intervals. The outer surface of the first cylindrical member 86 has a step 86c in which the inner surface of the bearing 88a fits. The bearing 88b is separate from the bearing 88a and is closer to the base-side part 121 than the bearing 88a is. Between the bearings 88a and 88b is a cylindrical collar 89 for maintaining the interval between the bearings 88a and 88b. It should be herein noted that the bearings 88a and 88b are thrust bearings.

In an application where the connecting element 85 is used, the threaded member 126 has a cylindrical shape elongated in the axial direction of the drive shaft 124. An end of the threaded member 126 which is closer to the tip-side part 122 is inserted inside the first cylindrical member 86. At an end of the threaded member 126 which is closer to the base-side part 121 is a flange 126b integrally formed by molding. The flange 126b has a plurality of through holes 126c axially penetrating at positions corresponding to the screw holes 86d. When a side of the connecting element 85 is seen, the bearings 88a and 88b overlap the hole 126a of the threaded member 126.

Provided between the first cylindrical member 86 and the flange 126b of the threaded member 126 is an annular holding member 90 for holding the bearings 88a and 88b between the step 86c and the holding member 90. The holding member 90 has a plurality of through holes 90a axially penetrating at positions corresponding to the screw holes 86d. Bolts 91 are inserted through the through holes 126c of the flange 126b and the through holes 90a of the holding member 90 and meshingly inserted into the screw holes 86d, whereby the holding member 90 and the threaded member 126 are made integral with the first cylindrical member 86. With this arrangement, the inner surfaces of the bearings 88a and 88b are fixed to the first cylindrical member 86.

Provided between the inner surface of an end of the second cylindrical member 87 which is closer to the tip-side part 122 and the outer surface of the first cylindrical member 86 is an annular sealing member 92. The inner surface of the second cylindrical member 87 has a step 87b in which the outer surface of the bearing 88a fits. An end of the second cylindrical member 87 which is closer to the base-side part 121 is provided with an annular abutting member 93 which abuts on the outer periphery of the bearing 88b. The abutting member 93 fixed to the second cylindrical member 87 by a bolt (not shown) or the like. With this arrangement, the second cylindrical member 87 is integral with the outer periphery of the bearings 88a and 88b so that the second cylindrical member 87 does not axially travel relative to the first cylindrical member 86. Meanwhile, the second cylindrical member 87 and the abutting member 93 are rotatable around the first cylindrical member 86. Provided between the inner surface of the abutting member 93 and the outer surface of the holding member 90 is a sealing member 92.

The end surface of an end of the abutting member 93 which is closer to the base-side part 121 has a plurality of axially-extending screw holes 93a as illustrated in FIG. 18. The screw holes 93a are aligned along the circumference of the abutting member 93 with certain intervals. The wall 121a of the base-side part 121 has through holes (not shown) at positions corresponding to the screw holes 93a. Bolts 83 (shown by imaginary lines in FIG. 18) are inserted through the through holes of the wall 121a and meshingly inserted into the screw holes 93a, whereby the second cylindrical member 87 and the abutting member 93 are made integral with the base-side part 121.

In the replacement arm component 120 having the above-described connecting element 85, when the moving device 125 is actuated to move the drive shaft 124 in the direction indicated by arrow X in FIG. 17, the first cylindrical member 86 integral with the threaded member 126 axially rotates relative to the second cylindrical member 87 which is integral with the base-side part 121 (indicated by arrow Y), so that the tip-side part 122 rotates relative to the base-side part 121.

Alternatively, the replacement arm component 120 may have a reciprocation element 140 for reciprocating the wrist 14 in the arm axis direction as shown in FIG. 19. The reciprocation element 140 includes a rod 140a and a principal part 140b for moving the rod 140a in the arm axis direction as does the base-side arm actuator 61. Although not shown, the reciprocation element 140 is connected to the robot controller 4. The rod 140a corresponds to the movable member of the claimed inventions, and the principal part 140b corresponds to the moving device of the claimed inventions.

In the example where the tip-side arm component 13 is replaced by the replacement arm component 120 having the reciprocation element 140, workpiece W can be moved in the arm axis direction only by powering a motor (not shown) of the reciprocation element 140 without rotating the rotating platform 6 or swinging the arm components 11 or 12. The moving direction of the wrist 14 can be changed by changing the rotation direction (forward or reverse) of the motor (not shown) of the reciprocation element 140. For example, in the process of installing a steering wheel of the vehicle, at the step of inserting a steering shaft in an attachment hole of the steering wheel, the robot arm 3 positions the steering wheel such that the attachment hole of the steering wheel is on an extension line of the steering shaft and that the arm axis line of the replacement arm component 120 is generally coincident with the extension line of the steering shaft. Thereafter, the steering shaft can be inserted in the attachment hole of the steering wheel only by advancing the wrist 14 in the arm axis direction using the reciprocation element 140. Thus, it is not necessary to control the platform actuator 8 or the arm components 11 or 12 for moving the wrist 14 in the arm axis direction. Therefore, the robot arm 3 can be easily controlled. This also applies to the step of inserting bolts in fastening holes of a tire wheel in a tire attaching process.

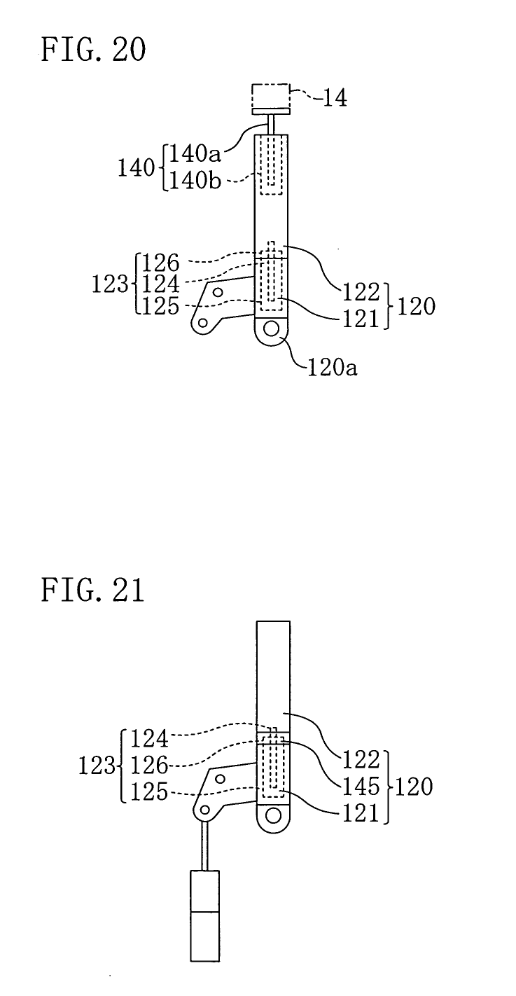

An alternative example of the replacement arm component 120 shown in FIG. 20 includes a base-side part 121 and a tip-side part 122. The replacement arm component 120 of FIG. 20 is provided with an arm rotator 123 for rotating the tip-side part 122 around the arm axis and the reciprocation element 140 in the tip-side part 122.

Another alternative example of the replacement arm component 120 shown in FIG. 21 includes three divisional parts, a base-side part 121, an intermediate part 145 and a tip-side part 122. The base-side part 121 contains a moving device 125 which axially moves a drive shaft 124. The intermediate part 145 contains a threaded member 126 meshed with the drive shaft 124. The drive shaft 124 protrudes from the threaded member 126 into the inside of the tip-side part 122. The end of the drive shaft 124 is fixed to the tip-side part 122. In this structure, as the drive shaft 124 axially travels, the tip-side part 122 travels in the arm axis direction relative to the base-side part 121.

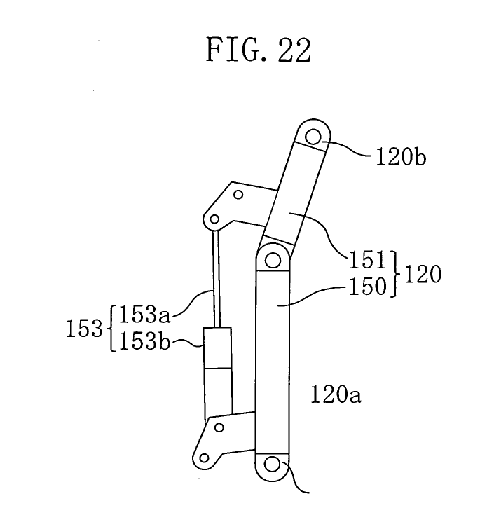

Still another example of the replacement arm component 120 shown in FIG. 22 is bendable at an axially intermediate position. The replacement arm component 120 includes a first arm portion 150 and a second arm portion 151, which are swingably connected to each other. For example, this connection structure is the same as the connection structure between the base-side arm component 11 and the intermediate arm component 12. There is provided an arm actuator 153 for swinging the first arm portion 150 relative to the second arm portion 151. The arm actuator 153 also includes a rod 153a and a principal part 153b as does the base-side arm actuator 61.

The above-described examples of the replacement arm component 120 can be arbitrarily combined and can also be used as the additional arm component 100. By using these elements, the shape of the robot arm 3 can be changed, and the flexibility in movement of the robot arm 3 can be improved.

As described above, in the industrial robot 1 of this embodiment, for example, the intermediate arm component 12 can be replaced by the replacement arm component 120 which has different movement and shape from those of the intermediate arm component 12. Thus, the movement and shape of the robot arm 3 can be readily modified according to detailed requirements in a work field, and therefore, the versatility of the robot arm 3 can be improved. Further, for example, the additional arm component 100 which has different movement and shape from those of the tip-side arm component 13 can be added to the robot arm 3, and therefore, the versatility of the robot arm 3 can be likewise improved. Thus, it is not necessary to develop a robot customized to a certain work field, and various workpieces can be carried without introducing a new-type robot into the work field. As a result, the equipment cost can be reduced, and accordingly, the production cost can be reduced.

Since the length of the robot arm 3 can be arbitrarily set by adding the additional arm component(s) 100, a workpiece W at a high place can be grasped, and alternatively, a workpiece W can be carried to a high place. Further, due to the improved flexibility in movement of the robot arm 3, even a task at a place difficult for a worker to access can be accomplished by the robot arm 3.

Although not shown, a plurality of types of arm actuators may be prepared according to the amount of stroke, propulsion speed and thrust of a rod, among which an arbitrary arm actuator is selected for combination with the replacement arm component 120. With this arrangement, even when workpiece W is changed to a different type, it is only necessary to replace the replacement arm component 120 with a suitable substitution. The amount of a stroke of the rod may be arbitrarily set by changing the length of the rod, for example, may be set within the range of about 100 mm to 1000 mm. The setting of the stroke can be realized by cutting a prepared material rod which is longer than expected in a work field.

The thrust and propulsion speed of the rods 61a to 63a and 107a can be arbitrarily set by, for example, changing the motor 32, changing the gear ratio of the speed reduction mechanism 34, or changing the pitch of the thread groove of the rods 61a to 63a and 107a. In the present embodiment, the propulsion speeds of the rods 61a to 63a and 107a are set such that the swing speeds of the arm components 11 to 13, 100, 120 are in the range of about 10 mm/s to 1000 mm/s. The thrusts of the rods 61a to 63a and 107a are set such that the weight of workpiece W graspable by the wrist 14 is in the range of about 5 kg to 300 kg.

The number of arm components of the robot arm 3 may be 2 or may be 4 or more. These arm components may have different lengths.

The industrial robot 1 may be used for, for example, removing a product molded by an injection molding machine, or the like, out of a mold die or attaching an insertion member to a mold die. Further, for example, it is also possible with the industrial robot 1 to transfer workpiece W from a pallet to another, to displace workpiece W from a pallet, and to place workpiece W on a pallet.

### INDUSTRIAL APPLICABILITY

As described above, an industrial robot of the present invention is suitable for, for example, carrying a workpiece in a vehicle assembly factory.

1. An industrial robot, comprising:
a robot arm including a plurality of first arm components swingably connected to one another; and
a base to which one of the first arm components at a base-side end of the robot arm is connected,
wherein the first arm component is driven by a thrust of a rod which has a thread groove in its outer surface, the rod being axially moved by rotating a nut meshed with the rod,
each of the first arm components has a connector which is detachably connected to a neighboring one of the first arm components, and
the connector is connectable to a replacement second arm component in place of the neighboring first arm component.

2. An industrial robot, comprising:
a robot arm including a plurality of first arm components swingably connected to one another; and
a base to which one of the first arm components at the base-side end of the robot arm is connected,
wherein the first arm component is driven by a thrust of a rod which has a thread groove in its outer surface, the rod being axially moved by rotating a nut meshed with the rod,
each of the first arm components has a connector which is detachably connected to a neighboring one of the first arm components, and
the connector is connectable to an additional second arm component added to the robot arm and included in the robot arm together with the first arm components.

3. The industrial robot of claim 1 or 2, wherein the length of the second arm component in its arm axis direction is different from the length of the first arm component in its arm axis direction.

4. The industrial robot of claim 1 or 2, wherein: the second arm component is divided into a base-side part and a tip-side part at an axially intermediate position; and the second arm component has rotation means for rotating the tip-side part around its arm axis relative to the base-side part.

5. The industrial robot of claim 1 or 2, wherein the second arm component includes a movable member and a moving device for moving the movable member in the arm axis direction of the second arm component.
